(19) United States
(12) Patent Application Publication
(10) Pub. No.: US 2020/0079468 A1
(43) Pub. Date: Mar. 12, 2020

(54) Small vehicle control user interface

(71) Applicant: Manuel Saez, Brooklyn, NY (US)

(72) Inventor: Manuel Saez, Brooklyn, NY (US)

(21) Appl. No.: 16/565,036

(22) Filed: Sep. 9, 2019

Related U.S. Application Data
(60) Provisional application No. 62/728,804, filed on Sep. 9, 2018.

(51) Int. Cl. B62M 6/50; B62K 21/12; B62K 3/00

(52) U.S. Cl. CPC B62M 6/50; B62K 3/002; B62K 21/12

(57) ABSTRACT

The control pad is a means for a rider to control a small vehicle using his/her hands or other body parts. The control pad may have the shape of a donut, a bar/rod, a handlebar for one or two hands, a sphere or a surface. The control pad may be sensitive to touch and can interpret a user's motion to receive the desired action request.

### CROSS REFERENCE TO RELATED APPLICATION

This application is related to and claims the benefit of U.S. Provisional Patent Application Ser. No. 62/728,804 (“the '804 application”), titled “Small vehicle control user interface,” which is incorporated by reference herein in its entirety for all purposes.

### BACKGROUND OF THE INVENTION

### Field of the Invention

The present invention relates to a system and method for controlling small vehicles via a control user interface. The invention relates to systems, methods and apparatus of control interfaces for small vehicles, and in a particular embodiment, to a control pad, such as for use with a skateboard or scooter.

### Description of Related Art

The related art includes, for instance, scooters with upright handlebars, skateboards without handlebars, and joystick controllers of small vehicles, such as remotely-controlled vehicles, including drones and toy cars. Distinctions between skateboards and scooters include that a scooter typically has a handle, has two inline wheels, and cannot stand upright on its own, whereas a skateboard typically has no handle, has three or four wheels, and can stand upright on its own. There is a need for a rider or user to be able to control the small vehicles that are increasingly popular in today's transportation industry. Ease of use is important, as is the mechanical composition of such interface. There exist remotely-controlled skateboards and battery-operated small vehicles, however none solves the problem or allows a user to directly interface and control their vehicle in a simple and intuitive way while riding and be able to control other small vehicles that they own and operate. In addition, none allows a user to control and operate the vehicle with a control pad that is mechanically integrated into the small vehicle.

As described below, embodiments of the present invention include a control interface for small vehicles, using systems and methods different from those of the prior art systems and methods.

### BRIEF SUMMARY OF THE INVENTION

The invention is directed to systems, methods and apparatus involving control interfaces for small vehicles, including skateboards and scooters, and, in particular, to a control pad integrated with an upright bar of a scooter.

In accordance with a first aspect of the invention, a small vehicle control user interface system is disclosed that comprises: a handle including a control pad having a hand grip, which may include a ring having a shape resembling a donut; wherein the control pad includes at least one handle sensor. The at least one handle sensor may include a pressure sensor, an accelerometer sensor, a rotation sensor, and/or a temperature sensor. The control pad further may include at least one control input device, which may include a switch, a button, a slider, a touch-sensitive pad, or a touch-sensitive screen. The control pad further may include a power source, such as a rechargeable battery and a charging circuit, and a communication device, such as a wireless transceiver. The control pad further may include a vibration generator adapted to provide haptic output. The control pad further may include a processor adapted to be interoperable with a smartphone app.

In accordance with a second aspect of the invention, a method for controlling a small vehicle is disclosed, the method comprising: (1) providing a small vehicle control user interface system including at least one sensor, at least one processor, at least one control input device, a power source, and a communication device; wherein the processor is adapted to control the small vehicle; and wherein the small vehicle control user interface is located in a control pad of a handle of the small vehicle, is coupled to a motor and a braking system of the small vehicle, and is adapted to control the motor and the braking system; wherein the control pad is adapted be sensitive to touch, and the processor is adapted interpret a user's motion and pressure to control the small vehicle; (2) sensing levels of the user's motion and pressure for determining the control of the vehicle; and (3) using sensed levels of the user's motion and pressure to determine the control of the vehicle.

In accordance with a third aspect of the invention, a small vehicle is disclosed that comprises: a handle including a control pad and a handle stem, the control pad having a hand grip; a foot deck connected to and supporting a lower end of the handle; a chassis connected to and supporting the foot deck, the chassis including a plurality of axles, at least one motor, a plurality of wheels, a suspension system, and a braking system; and a small vehicle control user interface system located in the handle, coupled to the motor and the braking system, and adapted to control the motor and the braking system; wherein the small vehicle control user interface system includes at least one sensor, at least one processor, at least on control input device, a power source, and a communication device; and wherein the hand grip includes a ring having a shape resembling a donut.

Further aspects of the invention are set forth herein. The details of exemplary embodiments of the invention are set forth in the accompanying drawings and the description below. Other features, objects, and advantages of the invention will be apparent from the description and drawings, and from the claims.

### BRIEF DESCRIPTION OF THE DRAWINGS

By reference to the appended drawings, which illustrate exemplary embodiments of this invention, the detailed description provided below explains in detail various features, advantages and aspects of this invention. As such, features of this invention can be more clearly understood from the following detailed description considered in conjunction with the following drawings, in which the same reference numerals denote the same, similar or comparable elements throughout. The exemplary embodiments illustrated in the drawings are not necessarily to scale or to shape and are not to be considered limiting of its scope, for the invention may admit to other equally effective embodiments having differing combinations of features, as set forth in the accompanying claims.

FIG. 1 shows a front side elevation perspective view of an exemplary embodiment of the invention depicting a small vehicle having an integrated control pad, according to aspects of the invention.

FIG. 2 shows a rear side perspective view of the exemplary embodiment of FIG. 1.

FIG. 3 shows a side elevation perspective view of the exemplary embodiment of FIG. 1.

FIG. 4 shows a rear perspective view of the exemplary embodiment of FIG. 1.

FIG. 5 shows a rear side elevation perspective view of the exemplary embodiment of FIG. 1.

### LISTING OF DRAWING REFERENCE NUMERALS

Below are reference numerals denoting the same, similar or comparable elements throughout the drawings and detailed description of the invention:
10000—a small vehicle—such as a hybrid scooter skateboard
   11000—a handle—
      11100—a control pad—
         11110—a handle sensor—
         11120—a control input device—
         11130—a hand grip—such as a ring-shaped grip
      11200—a handle stem—
         11210—a power source—
         11220—a sensor—
         11230—a processor—
         11240—a wireless transceiver—
   12000—a foot deck—
   13000—a chassis—
      13100—an axle—
         13110—a motor—
      13200—a wheel—
      13300—a suspension system—
         13310—a shock-absorbing spring—
      13400—a braking system—

### DETAILED DESCRIPTION OF THE INVENTION

The invention is directed to systems, methods and apparatus involving controls for small vehicles, such as skateboards and scooters.

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope, and contemplation of the invention.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

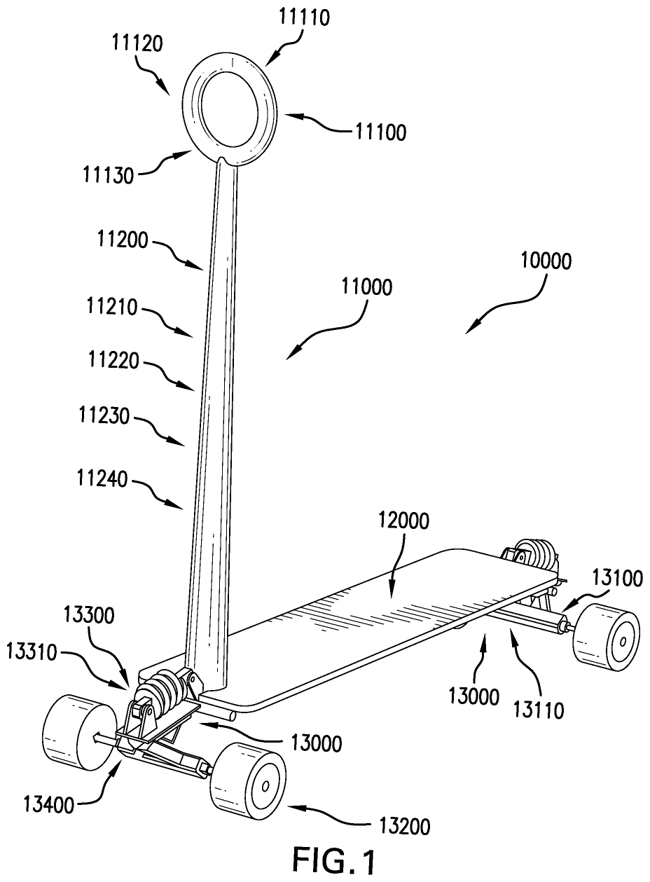

FIGS. 1-5 show the various components of the invention. The control pad is comprised of various sensors, including but not limited to sensors that measure pressure, temperature, speed (accelerometer) and rotation (gyroscope). Some sensors may be positioned elsewhere on the small vehicle, such as on a handle stem, to the extent that the position of the sensor does not impact the sensing of the criterion being sensed. The control pad is part of a larger system that comprises a processor, the sensors, and wired and/or wireless capabilities, through a communication device, such as communication chips (e.g., USB port), and/or a wireless transceiver, enabling, for instance, Bluetooth, Wi-Fi, Near-Field Communication (NFC), and/or Bluetooth Low-Energy (BLE). The control pad is powered either through a power source, such as a battery, solar cells, or induction. The power source may include a rechargeable battery (e.g., lithium ion battery), and likewise may include a charging circuit to recharge the battery. The processor may be adapted to handle or be interoperable with common operating systems, including iOS, Android, Microsoft Windows, etc., and be adapted to be interoperable with a related app running on such an operating system, such as a smartphone app.

The physical control, with which a user interfaces, comprises a control pad with control input devices, such as switches, buttons, sliders and digital or touch-sensitive pad, or touch-sensitive screen. The disclosed invention allows a user to connect the small vehicle to other wireless or plugged-in devices, thus allowing a user to have control and access to all the user's connected small vehicle devices.

The control pad is a means for a rider to control a small vehicle using his/her hands or other body parts. The control pad may have a hand grip having the shape of a donut, a ring, a bar/rod, a handlebar for one or two hands, a sphere or a surface. The control pad may be sensitive to touch and may interpret a user's motion to receive the desired action request. For example, to move the small vehicle forward, a user may press, push or pull the control pad forward. Levels of user interaction may determine the control of the vehicle; for example, the harder the pressure exerted by the user on the control pad, the faster the small vehicle moves. Pulling the control pad back from a forward position may cause the small vehicle to stop. The harder the pressure applied to move the control pad back from a forward position, the harder or faster the small vehicle stops. To reverse the small vehicle, a user may continue to pull the control pad with pressure, thereby instructing the small vehicle to go backwards, i.e., in reverse. Similarly, pressing, pulling, or exerting pressure on the control pad to the left instructs the processor to instruct the small vehicle to move to the left. Similarly, pressing, pulling, or exerting pressure on the control pad to the right instructs the processor to instruct the small vehicle to move to the right.

The control pad may also be comprised to understand and process haptic feedback from and to the user or rider on the small vehicle, such as through a haptic input sensor and/or a haptic output device, such as a vibration generator. The control pad may be a self-standing system or it may connect to other systems in the vehicle such as temperature control or any other electrical or mechanical systems in the small vehicle. FIGS. 1-5 show the control pad being used on a small vehicle such as a hybrid scooter-skateboard, but the control pad can be used on mini cars, driverless cars, electric bikes and scooters and any similar type of vehicle.

### Exemplary Embodiments of the Invention

Referring to the Figures, a small vehicle 10000 may include a handle 11000, a foot deck 12000, and a chassis 13000.

Referring to FIG. 1, FIG. 1 shows a front side elevation perspective view of an exemplary embodiment of the invention depicting a small vehicle 10000 having an integrated control pad, according to aspects of the invention. As depicted, the small vehicle 10000 comprises a hybrid scooter skateboard having a handle 11000, a foot deck 12000, and a chassis 13000.

The handle 11000 may include a control pad 11100 and a handle stem 11200. The control pad 11100 may include and/or contain one or more handle sensors 11110, one or more control input devices 11120, and a hand grip 11130, such as a ring-shaped grip. The control pad 11100 may comprise a metal, wood, plastic, or composite structure, such as the depicted ring-shaped hand grip 11130, that may be hollow, may contain hidden from view the handle sensors 11110, and may have the control input devices 11120 on the surface of the control pad 11100. The handle stem 11200 may include and contain, for instance, a power source 11210, one or more sensors 11220, one or more processors 11230, and one or more wireless transceivers 11240. In some embodiments, the control pad 11100 itself may include the power source 11210, the other sensors 11220, the processors 11230, and the wireless transceivers 11240. In some embodiments, both the control pad 11100 and the handle stem 11200 include some combination of the power source 11210, the other sensors 11220, the processors 11230, and the wireless transceivers 11240. The handle stem 11200 may comprise a metal, wood, plastic, or composite support bar, such as an elongated cone or tapered cylinder, that may be hollow and contain hidden from view the power source 11210, the sensors 11220, the processors 11230, and the wireless transceivers 11240.

The foot deck 12000 may comprise a metal, wood, plastic, or composite elongated substrate adapted to hold the weight of a user riding the small vehicle 10000. The foot deck 12000 is connected to and supporting a lower end of the handle 11000. The foot deck 12000 also may be adapted to stably support the handle 11000 as pressure is applied by the user to the handle 11000 during riding. The foot deck 12000 similarly may be adapted to stably support the chassis 13000 as weight is applied by the user during riding and the weight is transferred to the chassis 13000.

The chassis 13000 is connected to and supporting the foot deck 12000. The chassis 13000 may include a plurality of axles 13100, possibly one or more motors 13110 integrated in the chassis 13000, a plurality of wheels 13200, possibly a suspension system 13300 that may include, for instance, a plurality of shock-absorbing springs 13310, and possibly a braking system 13400 that may include, for instance, disc brakes, or capacitive brakes that have an electric motor 13110 work in reverse to slow the vehicle 10000 by recharging the power source 11210.

In some embodiments, the power source 11210 is adapted to provide electrical power to the handle sensors 11110, the control input devices 11120, the sensors 11220, the processors 11230, the wireless transceivers 11240, the motors 13110, and the braking system 13400. In some embodiments, the processors 11230 are electronically coupled to and adapted to electronically interact with the handle sensors 11110, the control input devices 11120, the power source 11210, the sensors 11220, the wireless transceivers 11240, the motors 13110, and the braking system 13400.

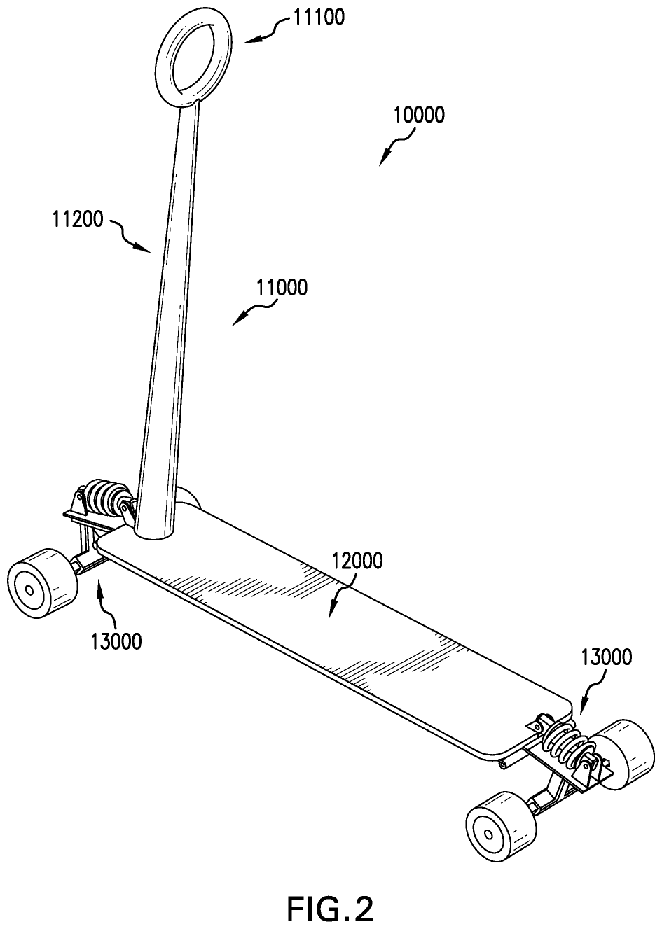

Referring to FIG. 2, FIG. 2 shows a rear side perspective view of the exemplary embodiment of FIG. 1.

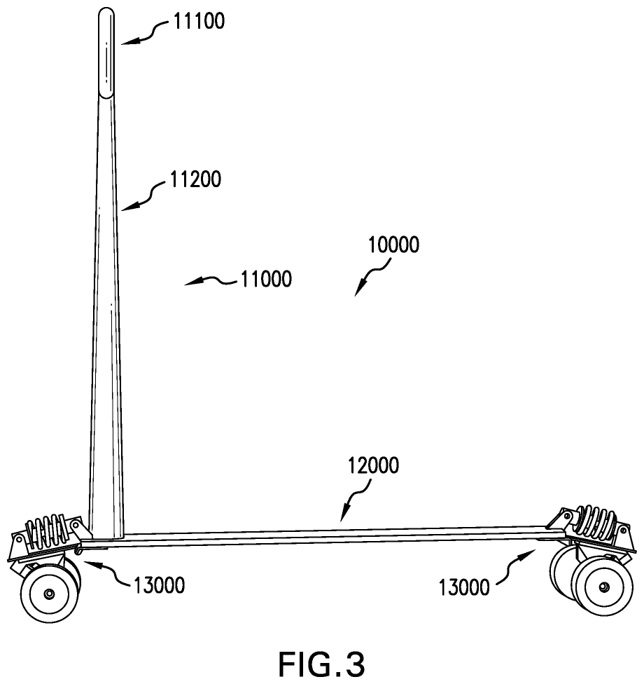

Referring to FIG. 3, FIG. 3 shows a side elevation perspective view of the exemplary embodiment of FIG. 1.

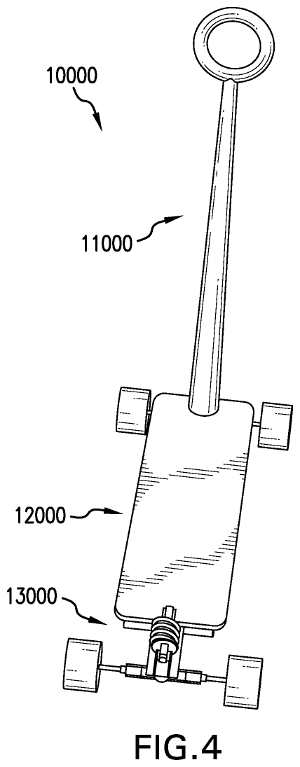

Referring to FIG. 4, FIG. 4 shows a rear perspective view of the exemplary embodiment of FIG. 1.

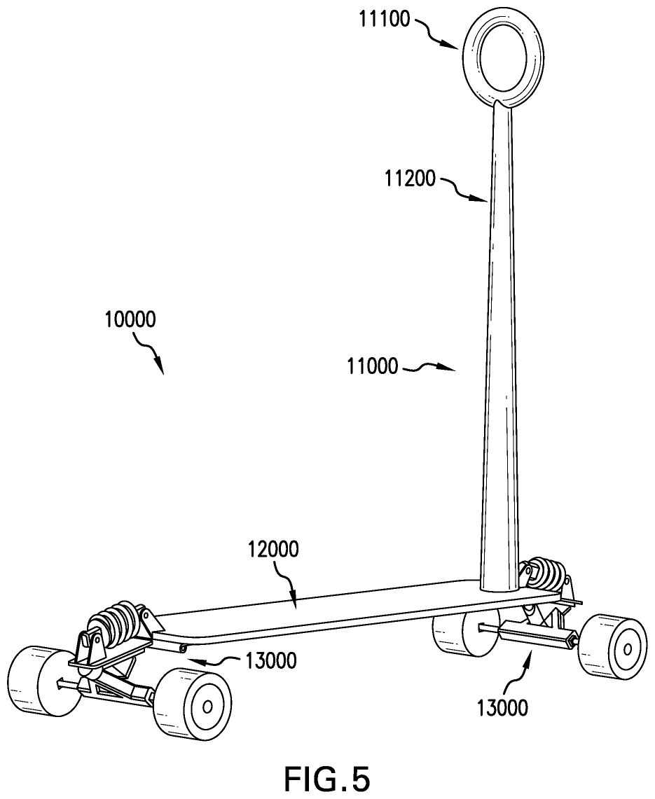

Referring to FIG. 5, FIG. 5 shows a rear side elevation perspective view of the exemplary embodiment of FIG. 1.

Methods in accordance with aspects of the invention include, for instance, the steps of: (1) providing a small vehicle control user interface system including at least one sensor, at least one processor, at least one control input device, a power source, and a communication device; wherein the processor is adapted to control the small vehicle; and wherein the small vehicle control user interface is located in a control pad of a handle of the small vehicle, is coupled to a motor and a braking system of the small vehicle, and is adapted to control the motor and the braking system; wherein the control pad is adapted be sensitive to touch, and the processor is adapted interpret a user's motion and pressure to control the small vehicle; (2) sensing levels of the user's motion and pressure for determining the control of the vehicle; and (3) using sensed levels of the user's motion and pressure to determine the control of the vehicle. The steps may further include: (4) moving the small vehicle faster as harder pressure is exerted by the user on the control pad; wherein the processor is adapted to cause the small vehicle to move faster the harder the pressure exerted by the user on the control pad. The steps may further include: (5) moving the small vehicle forward when sensing that a user is pressing, pushing or pulling the control pad forward; wherein the processor is adapted to move the small vehicle forward when sensing that a user is pressing, pushing or pulling the control pad forward; (6) stopping the small vehicle when sensing that a user is pulling the control pad back from a forward position; wherein the processor is adapted to cause the small vehicle to stop when sensing that a user is pulling the control pad back from a forward position; and wherein the processor is adapted to cause the small vehicle to stop harder or faster when sensing that the user is applying harder pressure to move the control pad back from a forward position; and (7) moving the small vehicle backward when sensing that the user is pulling the control pad backwards with pressure; wherein the processor is adapted to reverse the small vehicle when sensing that the user is pulling the control pad backwards with pressure. The steps may further include: (8) moving the small vehicle to the left when sensing that the user is pressing, pulling, or exerting pressure on the control pad to the left; wherein the processor is adapted to cause the small vehicle to move to the left when sensing that the user is pressing, pulling, or exerting pressure on the control pad to the left; and (9) moving the small vehicle to the right when sensing that the user is pressing, pulling, or exerting pressure on the control pad to the right; wherein the processor is adapted to cause the small vehicle to move to the right when sensing that the user is pressing, pulling, or exerting pressure on the control pad to the right.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the claimed invention will be readily apparent to those of ordinary skill in the art. Accordingly, other embodiments may fall within the spirit and scope of the claimed invention, as defined by the claims that follow hereafter.

In the description above, numerous specific details are set forth in order to provide a more thorough understanding of embodiments of the invention. It will be apparent, however, to an artisan of ordinary skill that the invention may be practiced without incorporating all aspects of the specific details described herein. Not all possible embodiments of the invention are set forth verbatim herein. A multitude of combinations of aspects of the invention may be formed to create varying embodiments that fall within the scope of the claims hereafter. In addition, specific details well known to those of ordinary skill in the art have not been described in detail so as not to obscure the invention. Readers should note that although examples of the invention are set forth herein, the claims, and the full scope of any equivalents, are what define the metes and bounds of the invention protection.

What is claimed is:

1. A small vehicle control user interface system comprising:
a handle including a control pad having a hand grip;
wherein the control pad includes at least one handle sensor.

2. The system of claim 1, wherein:
the at least one handle sensor includes a pressure sensor.

3. The system of claim 2, wherein:
the at least one handle sensor further includes an accelerometer sensor.

4. The system of claim 3, wherein:
the at least one handle sensor further includes a rotation sensor.

5. The system of claim 4, wherein:
the at least one handle sensor further includes a temperature sensor.

6. The system of claim 1, wherein:
the control pad further includes at least one control input device.

7. The system of claim 6, wherein:
the at least one control input device includes a switch, a button, a slider, a touch-sensitive pad, or a touch-sensitive screen.

8. The system of claim 1, wherein:
the control pad further includes a power source and a communication device.

9. The system of claim 8, wherein:
the communication device includes a wireless transceiver.

10. The system of claim 8, wherein:
the power source includes a rechargeable battery and a charging circuit.

11. The system of claim 10, wherein:
the control pad further includes a vibration generator adapted to provide haptic output.

12. The system of claim 8, wherein:
the control pad further includes a processor adapted to be interoperable with a smartphone app.

13. The system of claim 12, wherein:
the processor is adapted to control a small vehicle;
wherein the control pad is adapted be sensitive to touch, and the processor is adapted interpret a user's motion and pressure to control the small vehicle;
wherein levels of the user's motion and pressure determine the control of the vehicle, such that the harder the pressure exerted by the user on the control pad, the faster the small vehicle moves;
wherein the processor is adapted to move the small vehicle forward when sensing that a user is pressing, pushing or pulling the control pad forward;
wherein the processor is adapted to cause the small vehicle to stop when sensing that a user is pulling the control pad back from a forward position;
wherein the processor is adapted to cause the small vehicle to stop harder or faster when sensing that the user is applying harder pressure to move the control pad back from a forward position;
wherein the processor is adapted to reverse the small vehicle when sensing that the user is pulling the control pad backwards with pressure;
wherein the processor is adapted to cause the small vehicle to move to the left when sensing that the user is pressing, pulling, or exerting pressure on the control pad to the left; and
wherein the processor is adapted to cause the small vehicle to move to the right when sensing that the user is pressing, pulling, or exerting pressure on the control pad to the right.

14. The system of claim 1, wherein:
the hand grip includes a ring having a shape resembling a donut.

15. A method for controlling a small vehicle, the method comprising:
providing a small vehicle control user interface system including at least one sensor, at least one processor, at least one control input device, a power source, and a communication device;
wherein the processor is adapted to control the small vehicle; and
wherein the small vehicle control user interface is located in a control pad of a handle of the small vehicle, is coupled to a motor and a braking system of the small vehicle, and is adapted to control the motor and the braking system;
wherein the control pad is adapted be sensitive to touch, and the processor is adapted interpret a user's motion and pressure to control the small vehicle;
sensing levels of the user's motion and pressure for determining the control of the vehicle; and
using sensed levels of the user's motion and pressure to determine the control of the vehicle.

16. The method of claim 15, further comprising:
moving the small vehicle faster as harder pressure is exerted by the user on the control pad;
wherein the processor is adapted to cause the small vehicle to move faster the harder the pressure exerted by the user on the control pad.

17. The method of claim 15, further comprising:
moving the small vehicle forward when sensing that a user is pressing, pushing or pulling the control pad forward;
wherein the processor is adapted to move the small vehicle forward when sensing that a user is pressing, pushing or pulling the control pad forward;
stopping the small vehicle when sensing that a user is pulling the control pad back from a forward position;
wherein the processor is adapted to cause the small vehicle to stop when sensing that a user is pulling the control pad back from a forward position; and
wherein the processor is adapted to cause the small vehicle to stop harder or faster when sensing that the user is applying harder pressure to move the control pad back from a forward position; and
moving the small vehicle backward when sensing that the user is pulling the control pad backwards with pressure;
wherein the processor is adapted to reverse the small vehicle when sensing that the user is pulling the control pad backwards with pressure.

18. The method of claim 15, further comprising:
moving the small vehicle to the left when sensing that the user is pressing, pulling, or exerting pressure on the control pad to the left;
wherein the processor is adapted to cause the small vehicle to move to the left when sensing that the user is pressing, pulling, or exerting pressure on the control pad to the left; and
moving the small vehicle to the right when sensing that the user is pressing, pulling, or exerting pressure on the control pad to the right;
wherein the processor is adapted to cause the small vehicle to move to the right when sensing that the user is pressing, pulling, or exerting pressure on the control pad to the right.

19. The method of claim 15, wherein:
the hand grip includes a ring having a shape resembling a donut.

20. A small vehicle comprising:
a handle including a control pad and a handle stem, the control pad having a hand grip;
a foot deck connected to and supporting a lower end of the handle;
a chassis connected to and supporting the foot deck, the chassis including a plurality of axles, at least one motor, a plurality of wheels, a suspension system, and a braking system; and
a small vehicle control user interface system located in the handle, coupled to the motor and the braking system, and adapted to control the motor and the braking system;
wherein the small vehicle control user interface system includes at least one sensor, at least one processor, at least on control input device, a power source, and a communication device; and
wherein the hand grip includes a ring having a shape resembling a donut.
